(19) United States
(12) Patent Application Publication
(10) Pub. No.: US 2026/0113647 A1
(43) Pub. Date: Apr. 23, 2026

(54) RADIO FREQUENCY PROCESSING SYSTEM AND METHOD

(71) Applicant: Raytheon Applied Signal Technology, Inc., San Jose, CA (US)

(72) Inventor: Jonathan Charles WINTRODE, Annapolis, MD (US)

(73) Assignee: Raytheon Applied Signal Technology, Inc., San Jose, CA (US)

(21) Appl. No.: 18/920,186

(22) Filed: Oct. 18, 2024

(51) Int. Cl. H04W 24/08; G06F 18/213

(52) U.S. Cl. CPC H04W 24/08; G06F 18/213

(57) ABSTRACT

A radio frequency signal identification system receives a signal having a plurality of ordered chunks. The ordered chunks are provided to a neural network that creates a respective feature vector for each of the ordered chunks. Each of a plurality of modeled signals include a wireless feature vector. A similarity function module compares a first feature vector for a first ordered chunk to the modeled signals using a similarity function. First feature vector probabilities are generated A first entropy value is determined based on the first feature vector probabilities. A second feature vector for a second ordered chunk is compared to the modeled signals using the similarity function to generate second feature vector probabilities. A second system entropy value is determined based on the second feature vector probabilities. The neural network ceases processing of the ordered chunks based on the first feature vector probabilities and the second feature vector probabilities.

### BACKGROUND OF THE INVENTION

### 1. Technical Field

The present disclosure is related to wireless data processing and, in particular, to a system and method for identifying a wireless protocol in recorded wireless data which reduce processing time and improve identification efficiency and throughput.

### 2. Discussion of Related Art

In wireless data processing, it is often desirable to identify the protocol being transmitted by a wireless device in recorded wireless data. Wireless signal identification (WID) is the labeling of wireless data recordings with the identity of the protocol being transmitted. Wireless signal identification can require a large amount of processing resources due to the amount of recorded wireless data typically being analyzed to make the identification determination.

It may be appreciated that there is a need for processing signals faster and using less resources.

### SUMMARY OF THE INVENTION

A radio frequency signal identification system is disclosed. The radio frequency signal identification system includes a radio to receive a signal. The signal includes a plurality of ordered chunks. The radio frequency signal identification system also includes a feature extraction neural network to receive the plurality of ordered chunks. The feature extraction neural network creates a respective feature vector for each of the plurality of ordered chunks of the signal. The radio frequency signal identification system also includes a plurality of modeled signals. Each of the plurality of modeled signals include a wireless feature vector corresponding to a unique signal. The radio frequency signal identification system also includes a similarity function module configured to compare a first feature vector for a first ordered chunk of the plurality of chunks to the plurality of modeled signals using a similarity function. The similarity function module also is configured to generate a plurality of first feature vector probabilities that indicate whether the signal corresponds to one of the plurality of modeled signals. The similarity function module also is configured to determine a first system entropy value based on the first feature vector probabilities. The similarity function module also is configured to compare a second feature vector for a second ordered chunk of the plurality of chunks to the plurality of modeled signals using the similarity function. The similarity function module also is configured to generate a plurality of second feature vector probabilities that indicate whether the signal corresponds to one of the modeled signals. The similarity function module also is configured to determine a second system entropy value based on the plurality of second feature vector probabilities. The feature extraction neural network ceases processing of the plurality of ordered chunks based on the first system entropy value and the second system entropy value.

A method for identifying a radio frequency signal is disclosed. The method includes dividing the radio frequency signal into a plurality of ordered chunks. The method also includes feeding the plurality of ordered chunks into a feature extraction neural network. The method also includes creating a respective feature vector for each of the plurality of ordered chunks of the signal by the feature extraction neural network. The method also includes comparing a first feature vector for a first ordered chunk of the plurality of ordered chunks to a plurality of modeled signals using a similarity feature. The method also includes generating a plurality of first feature vector probabilities that indicate whether the signal corresponds to one of the plurality of modeled signals. The method also includes determining a first system entropy value based on the first feature vector probabilities. The method also includes comparing a second feature vector for a second ordered chunk of the plurality of ordered chunks to the plurality of modeled signals using the similarity function. The method also includes generating a plurality of second feature vector probabilities that indicate whether the signal corresponds to one of the plurality of modeled signals. The method also includes determining a second system entropy value based on the plurality of second feature vector probabilities. The method also includes ceasing processing of the plurality of ordered chunks by the feature extraction neural network based on the first system entropy value and the second system entropy value.

A non-transitory computer-readable medium having stored thereon processor-executable instructions for performing operations for identifying a radio frequency signal. The operations include dividing the radio frequency signal into a plurality of ordered chunks. The operations also include feeding the plurality of ordered chunks into a feature extraction neural network. The operations also include creating a respective feature vector for each of the plurality of ordered chunks of the signal by the feature extraction neural network. The operations also include comparing a first feature vector for a first ordered chunk of the plurality of ordered chunks to a plurality of modeled signals using a similarity feature. The operations also include generating a plurality of first feature vector probabilities that indicate whether the signal corresponds to one of the plurality of modeled signals. The operations also include determining a first system entropy value based on the first feature vector probabilities. The operations also include comparing a second feature vector for a second ordered chunk of the plurality of ordered chunks to the plurality of modeled signals using the similarity function. The operations also include generating a plurality of second feature vector probabilities that indicate whether the signal corresponds to one of the plurality of modeled signals. The operations also include determining a second system entropy value based on the plurality of second feature vector probabilities. The operations also include ceasing processing of the plurality of ordered chunks by the feature extraction neural network based on the first system entropy value and the second system entropy value.

### BRIEF DESCRIPTION OF FIGURES

The present disclosure is further described in the detailed description which follows, in reference to the noted plurality of drawings by way of non-limiting examples of embodiments of the present disclosure, in which like reference numerals represent similar parts throughout the several views of the drawings.

FIG. 1 includes a schematic functional block diagram of a wireless classification system 200, according to some exemplary embodiments.

FIG. 2A includes a schematic functional block diagram illustrating the wireless classification system of FIG. 1, performing wireless signal identification, according to some exemplary embodiments.

FIG. 2B includes a schematic functional block diagram illustrating the wireless classification system of FIG. 1, performing wireless signal identification, according to some exemplary embodiments.

FIG. 2C includes a schematic functional block diagram illustrating the wireless classification system of FIG. 1, performing wireless signal identification, according to some exemplary embodiments.

FIG. 3A is a curve illustrating an example of the Euclidean similarity function.

FIG. 3B is a curve illustrating an example of the Cosine similarity function.

FIG. 4 illustrates a schematic functional block diagram which illustrates an X-vector neural network structure.

FIG. 5A illustrates a graph of a probability for an exemplary wireless protocol, expressed as a bar chart, illustrating the relationship between protocol probability scores and entropies.

FIG. 5B illustrates a graph of a probability for an exemplary wireless protocol, expressed as a bar chart, illustrating the relationship between protocol probability scores and entropies.

FIG. 5C illustrates a graph of a probability for an exemplary wireless protocol, expressed as a bar chart, illustrating the relationship between protocol probability scores and entropies.

FIG. 5D illustrates a graph of a probability for an exemplary wireless protocol, expressed as a bar chart, illustrating the relationship between protocol probability scores and entropies.

FIG. 6A illustrates a schematic block diagram that illustrates an identification of a protocol in unknown wireless data, after processing all segments of input data, according to some exemplary embodiments.

FIG. 6B illustrates a schematic block diagram that illustrates an identification of a protocol in unknown wireless data, after processing all segments of input data, according to some exemplary embodiments.

FIG. 6C illustrates a schematic block diagram that illustrates an identification of a protocol in unknown wireless data, after processing all segments of input data, according to some exemplary embodiments.

FIG. 7A illustrates a schematic block diagram that illustrates an identification of a protocol in unknown wireless data, after processing fewer than all segments of input data, according to some exemplary embodiments.

FIG. 7B illustrates a schematic block diagram that illustrates an identification of a protocol in unknown wireless data, after processing fewer than all segments of input data, according to some exemplary embodiments.

FIG. 8 illustrates a radio frequency machine learning system, according to some exemplary embodiments.

FIG. 9 illustrates a computing device in accordance with one or more exemplary embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

Wireless signal identification (WID) is the labeling of unknown wireless data (recorded transmissions) with the identity of a wireless protocol being transmitted by a device whose data is contained within the recorded transmissions. Some approaches to WID may include an offline component (training) and a runtime component (recognition). The “fast forward” approach of the current disclosure improves this architecture by speeding up the recognition component.

In some embodiments, WID systems perform recognition of new wireless data recordings by applying a feature extraction module, which computes a low-dimensional feature vector from the entire recorded duration. This feature vector is compared, using a similarity function, to a set of known feature vectors, one feature vector per target wireless protocol. The similarities between the compared unknown feature vector and the known-protocol feature vectors are output as probabilities of detection for each of the multiple wireless signaling protocols being compared.

In the “fast-forward” approach of the present disclosure, the above system flow is improved upon such that wireless protocol detections/determinations are reported without using the entire recording of unknown wireless data transmissions. According to the present disclosure, a feature vector is computed on each of one or more segments, i.e., “chunks,” of the new unknown wireless transmissions. That is, according to the approach of the disclosure, a feature vector for the entire wireless data recording is not generated. The similarity function is applied to these individual segment feature vectors, and probabilities between the segment feature vectors and each of the known feature vectors for each type of wireless signaling protocol are obtained. For each segment, the entropy of the set of probabilities is computed. If the entropy from one segment to the next decreases, then the certainty of the wireless protocol with the highest similarity being the correct determination increases to the point that the most likely protocol will not change with more data.

With this conclusion, processing is stopped early, i.e., before the entire unknown wireless transmission file is processed. This approach of the present disclosure reduces the amount of recorded wireless data needed at runtime to make a wireless protocol designation, which directly reduces the processing cost and resources in terms of computation cycles. According to the present disclosure, using incremental processing and entropy-based processing termination, the overall computation load is reduced, and processing speed is increased. The approach of the present disclosure can be implemented as an add-on module that enhances the runtime performance of any existing wireless signal identification system.

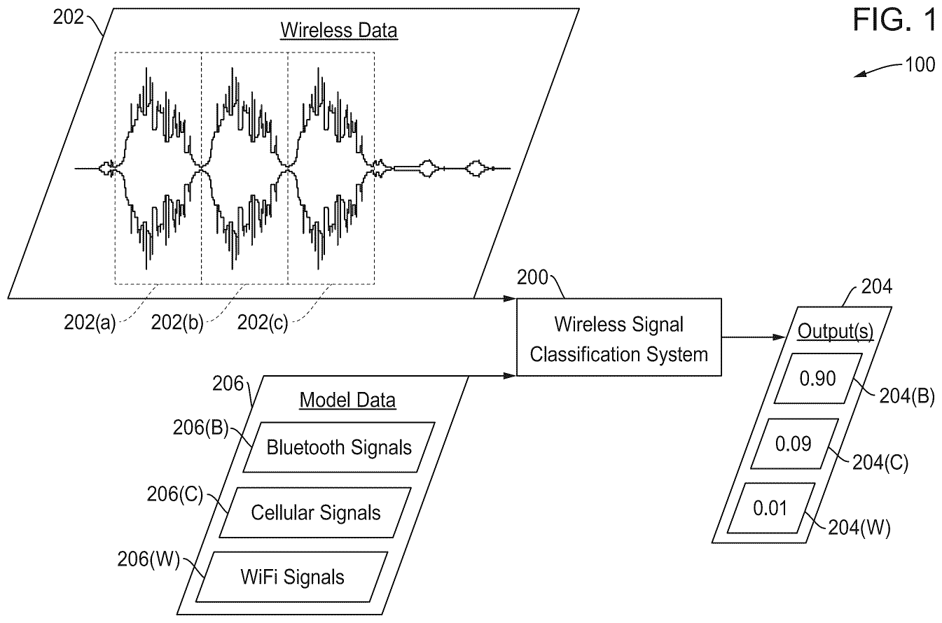

FIG. 1 includes a schematic functional block diagram of a wireless signal classification system 200, according to some exemplary embodiments. Referring to FIG. 1, system 100 takes in recorded wireless data 202, which includes segments or “chunks” 202(a), 202(b), 202(c), from unknown wireless sources of any length, which, in some particular exemplary embodiments, is in the form of a .sniff file. System 200 also takes in wireless model data 206 for known wireless signaling protocols, for example, as illustrated in FIG. 1, model data 206 can include wireless model data for Bluetooth signals 206(B), wireless model data for cellular signals 206(C), and wireless model data for WiFi signals 206(W). Model data 206 represent what makes each of the respective known wireless protocols distinct from other known wireless protocols. Outputs 204 from system 200 include scores which represent probabilities that the input data segment 202(a), 202(b), 202(c) currently being processed includes the known wireless signaling protocols. For example, as illustrated in FIG. 1, outputs 204 include a probability score 204(B) that the input data segment includes Bluetooth signals; a probability score 204(C) that the input data segment includes Cellular signals; and a probability score 204(W) that the input data segment includes WiFi signals.

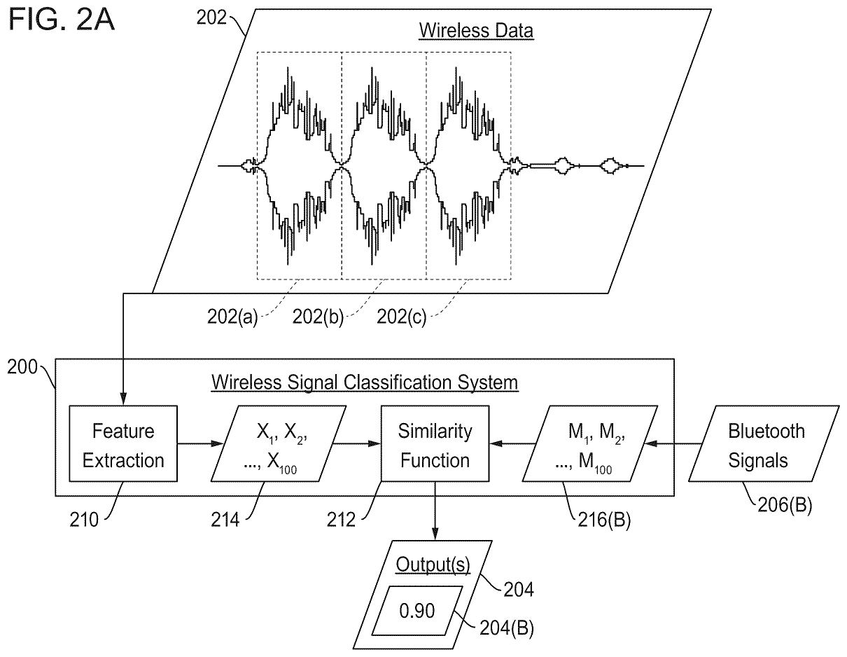

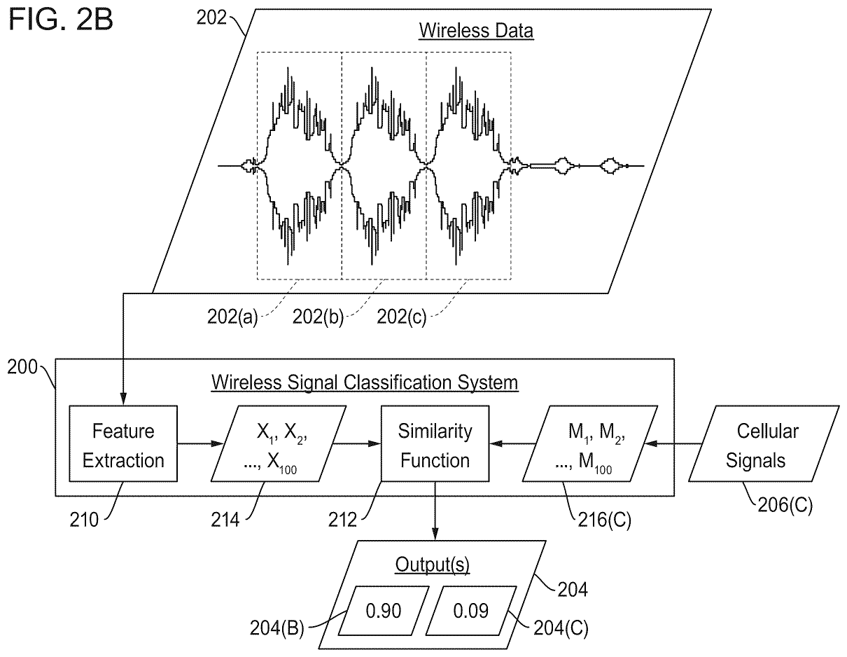

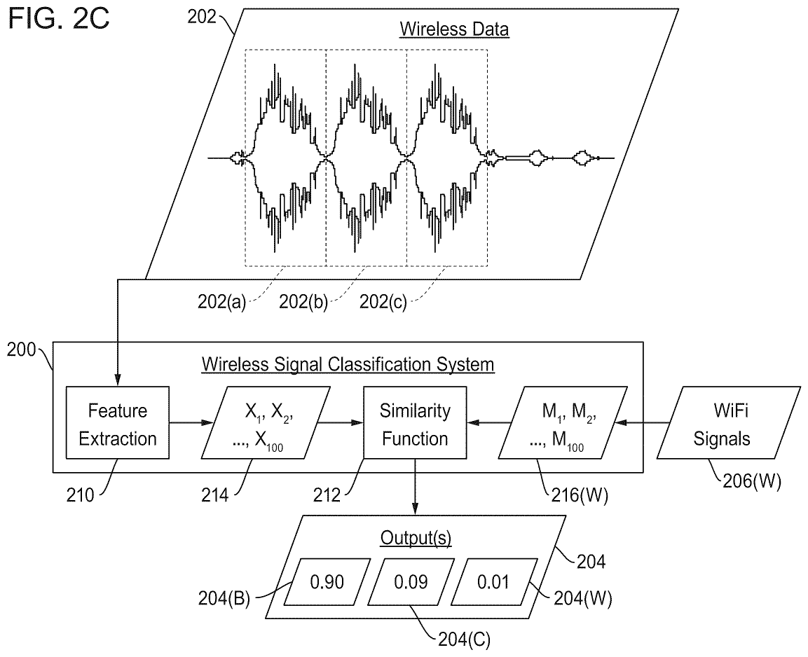

FIGS. 2A through 2C include schematic functional block diagrams illustrating wireless signal classification system 200 of FIG. 1 carrying out wireless signal identification in two stages, according to some exemplary embodiments. Referring to FIGS. 2A-2C, wireless signal classification system 200 includes feature extraction module 210, which may comprise a first stage, and similarity function module 212, which may comprise a second stage. Wireless input data 202, which includes segments or “chunks” 202(a), 202(b), 202(c), processed one at a time, is provided to feature extraction module 210, which outputs a feature vector 214, denoted X, which in some exemplary embodiments is a fixed-length list of decimal values xᵢ. In some exemplary embodiments, feature X-vector 214 includes 100 decimal values x₁, x₂, . . . , x₁₀₀. X-vector 214 represents wireless data of the segment 202(a), 202(b), 202(c) being processed. X-vector 214 is then input to similarity function module 212, which measures the distance between feature X-vector 214 and known wireless model data 206 M-vectors 216. These distances, or similarity scores, are normalized so that they sum to 1.0 and can be interpreted as probabilities.

In the embodiment illustrated in FIGS. 2A-2C, an M-vector 216 is generated for each known wireless signaling model. That is, Bluetooth M-vector 216(B) is generated from known Bluetooth model data 206(B) as shown in FIG. 2A; Cellular M-vector 216(C) is generated from known Cellular model data 206(C) as shown in FIG. 2B; and WiFi M-vector 216(W) is generated from known WiFi model data 206(W) as shown in FIG. 2C. Similarity function module 212 computes a distance between the X-vector 214 for the current input data segment 202(a), 202(b), 202(c) being processed and M-vector 216 for each wireless protocol in wireless model data 206; subsequently generates therefrom a probability that the current input data segment 202(a), 202(b), 202(c) being processed includes the wireless protocol represented by each M-vector 216(B), 216(C), 216(W); and outputs the probability as a probability scored. For example, referring to FIG. 2A, the probability score indicating the probability that the current input data segment 202(a), 202(b), 202(c) being processed includes Bluetooth signals is 0.90; referring to FIG. 2B, the probability score indicating the probability that the current input data segment 202(a), 202(b), 202(c) being processed includes Cellular signals is 0.09; and, referring to FIG. 2C, the probability score indicating the probability that the current input data segment 202(a), 202(b), 202(c) being processed includes WiFi signals is 0.01.

The feature extraction process 210, which generates the input data segments, is the slowest and most processing-intensive part of the process. According to the approach of the present disclosure, the amount of input data, i.e., the number of input data segments, required to be processed to arrive at a wireless signal identification is substantially reduced, resulting in a more efficient wireless signal identification process and system.

It will be understood that either or both of feature extraction module 210 and similarity function module 212 include all of the processing capabilities required to carry out their individual functions and the overall functions of wireless classification system 200, as described herein in detail. These processing capabilities can be implemented in either or both modules 210, 212, and can include for example, one or more dedicated processors, memories, input/output devices, interconnection devices, and any other required devices or subsystems. Alternatively, these modules 210, 212 and system 200 can be implemented on a general purpose computer executing instructions to implement the technology described herein.

Feature extraction module 210 takes wireless data 202 as input, and outputs a fixed-dimensional feature vector 214, i.e., X-vector as shown in FIGS. 2A-2C. By fixed-dimensional, what is meant is that recorded wireless data of any length (5 min, 10 min, 60 min) is transformed into a vector made up of the same number of decimal values (typically 100-500).

$$X = Extract ( wireless data ) \qquad ( 1 )$$

Similarity Module takes two vectors, i.e., unknown wireless data X-vector 214 and known wireless model M-vector 216 as input and outputs a single numeric value that captures the “closeness” of the vectors. For example, a similarity function can be defined as:

$$S = Similarity ( X , Y ) \qquad ( 2 )$$

The intuition to this function is that the larger the value of S, the “closer”, i.e., more similar, X and Y are. Two common geometric similarity functions are the Euclidian distance and Cosine similarity. The distance function is turned into a similarity function by subtracting from 1. The Euclidean distance in two dimensions is another name for the Pythagorean Theorem.

$$S = Similarity ( X , Y ) \qquad ( 3 )$$

$$S = 1 - Distance ( X , Y ) \qquad ( 4 )$$

$$S = 1 - \sqrt{{( {x}_{1} - {y}_{1} )}^{2} + {( {x}_{2} - {y}_{2} )}^{2}} \qquad ( 5 )$$

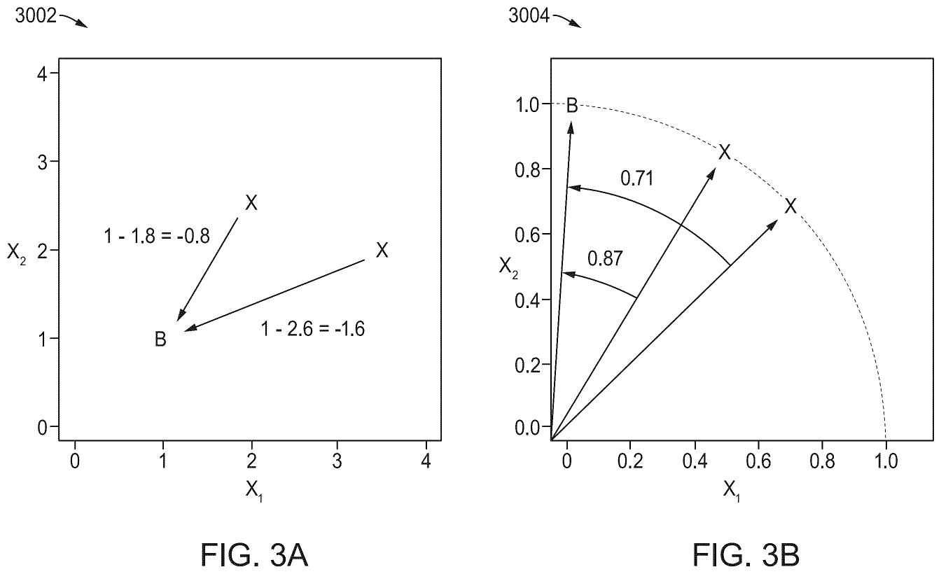

The Cosine similarity captures the angle between two vectors and is a common metric used in high dimensions (greater than 3). FIG. 3A is a curve 3002 illustrating an example of the Euclidean similarity function, and FIG. 3B is a curve 3004 illustrating an example of the Cosine similarity function. The Cosine similarity quantifies the angle between the two X vectors, starting at the origin, (0,0), and terminating at the points marked X in FIG. 3B, and the vector terminating at the letter B, which represents the protocol model. These metrics are illustrated in two dimensions but have well-defined constructions in higher dimensions.

Probability functions, which return a value of 0 to 1, are also an intuitive set of similarity functions. If there is a probability that X and Y are the same, then the higher the probability S=P (X,Y), the “closer” or more similar X and Y are. In some exemplary embodiments, the similarity function 212 is Probabilistic Linear Discriminant Analysis (PLDA). PLDA is a probability-based metric that is a log-likelihood ratio, a comparison of two probabilities:

$$S = log ( \frac{P ( Signal is Cellular )}{P ( Signal is not Cellular )} ) \qquad ( 6 )$$

PLDA and other log-likelihood ratios range from −∞ to ∞, with 0 being the point at which it is completely uncertain whether the unknown wireless data is the known wireless protocol. Positive values indicate that it is more likely than not to be the known protocol, and negative values indicate that it is more likely than not that the unknown data includes the known protocol. This fits the requirement for a similarity metric in that larger values of S mean “closer” or “more similar.”

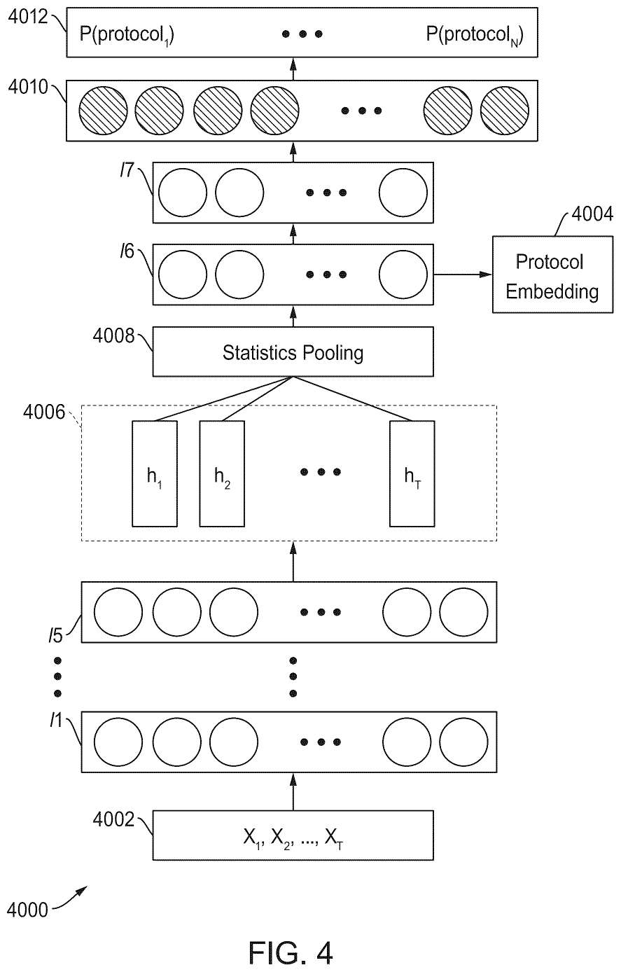

According to some exemplary embodiments, feature extraction module 210 uses a neural network model, which is commonly referred to as an x-vector extractor. The x-vector neural network is an extraction function that satisfies the condition for equation 1 but is internally implemented with a neural network. FIG. 4 includes a schematic functional block diagram 4000 that illustrates the x-vector neural network structure. FIG. 4 is a modified version of FIG. 1. Referring to FIG. 4, the “protocol embedding” 4004 refers to the output feature (segment) vector, and X (x₁, x₂, . . . , x_{T}) refers to the wireless data feature input 4002. The network of FIG. 4 is a feed-forward network, in that the inputs to each layer (denoted l₁ through l₇) are multiplied with a weight matrix, followed by the application of a nonlinear function to each output dimension. The output dimensionality for a layer is represented by the number of nodes in that layer. Each node has a weight associated with each input dimension, so each layer can be represented by an M×N dimensional weight matrix, where M is the number of inputs and N the number of outputs. The outputs of layer i are in turn used as the inputs to layer i+1. In FIG. 4, the “protocol embedding” 4004 is the output of layer l₆.

As illustrated below in detail, adding additional recorded wireless data into feature extraction module 210, without re-initializing the network, gives a better estimate of feature vector 214. It is related to the effect in statistical estimation that more data points give a more accurate measurement estimate.

According to the present disclosure, entropy of the probability scores 204 is computed and analyzed to determine whether processing can be stopped before all of the input wireless data 202 is processed. Entropy is a measure of uncertainty and is computed over the set of probability scores. Specifically, if the unknown wireless input data must be one of N known wireless protocols, entropy E can be computed from the probability P(j) that the unknown input data is protocol j, as follows:

$$E = - {\sum }_{j = 1}^{N} P ( j ) \cdot log P ( j ) \qquad ( 7 )$$

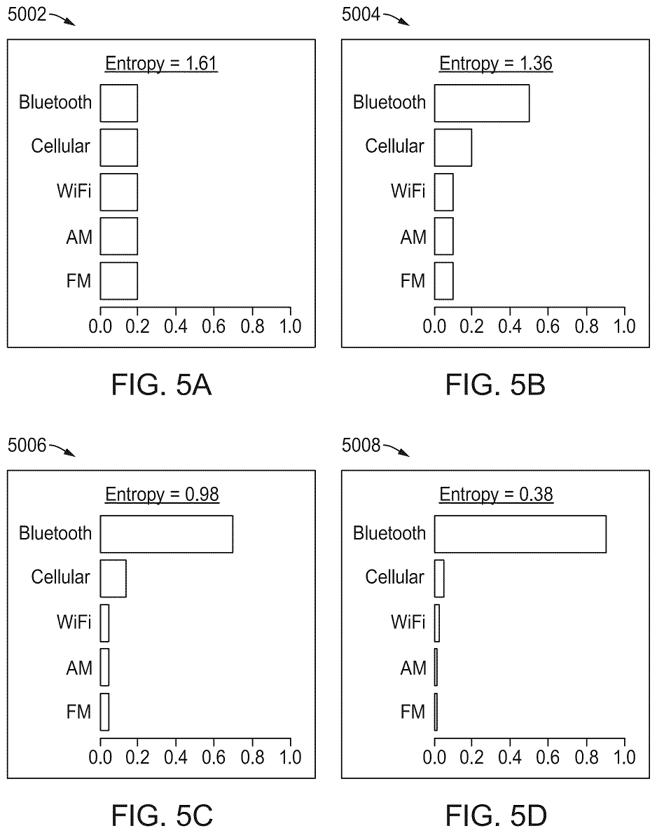

Entropy is mathematically zero when it is entirely certain of one protocol, for example, if P(Bluetooth)=1. In contrast, entropy is highest when uncertainty is equal across all protocols, for example, when P(Bluetooth)=P(Cellular)=P(WiFi)=0.33. FIGS. 5A through 5D include graphs of probabilities for five exemplary protocols, expressed as bar charts, illustrating the relationship between protocol probability scores and entropies. Referring to graph 5002 of FIG. 5A, with all protocols having an equal probability of 0.2, entropy, i.e., uncertainty, is relatively high at 1.61. Graph 5004 of FIG. 5B illustrates the case in which one protocol has a higher probability than the rest of the protocols, and the resulting entropy is lower at 1.36. Graph 5006 of FIG. 5C illustrates the case in which one protocol is even more dominant, resulting in a lower entropy of 0.98. Graph 5008 of FIG. 5D illustrates the case in which a single protocol is very dominant over the others, resulting in very high certainty and, therefore, very low entropy at 0.38.

According to some exemplary embodiments, similarity scores are converted to probabilities, and then the probabilities are converted to entropies. To that end, the similarity scores are first transformed to positive values, preserving their relative magnitudes. Then, each is divided by the sum of the scores, which results in N values that sum to 1.

According to the approach of the present disclosure, as noted above, the two main components of a wireless signal identification system, i.e., feature extraction 210 and similarity 212 operations, are used in efficiently producing a wireless signal identification in wireless data of an unknown protocol. System 200 receives as inputs the unknown data 202 and a set of target protocol models 206, e.g., Bluetooth 206(B), Cellular 206(C), and WiFi 206(W). System 200 generates as outputs a set of probabilities for each protocol.

According to the present disclosure, input wireless data 202 is broken into multiple adjacent chunks or segments 202(a), 202(b), 202(c) of a particular time duration, for example, c=10 min, each. For each chunk i from 0 to N (the number of chunks), feature extraction 210 is called to compute a feature vector X[i]. Similarity function 212 is called to compute similarity scores S[i] for each target protocol model M[j] 206, i.e., Similarity (X[i], M[j]), where j ranges from 1 to L, where L is the number of protocol models 206, which in the illustrated embodiments is three. The similarity scores are normalized to probabilities P[j] for each protocol j, as noted above. The entropy of the protocol probabilities is computed as E[i], for each chunk i. If entropy drops from one chunk to the next succeeding chunk, that is, if E[i]<E[i−1], then processing stops, even if all chunks 202(a), 202(b), 202(c) have not been processed. According to exemplary embodiments, the last set of probability scores P[j] for each protocol j are returned as the final probability scores for each protocol.

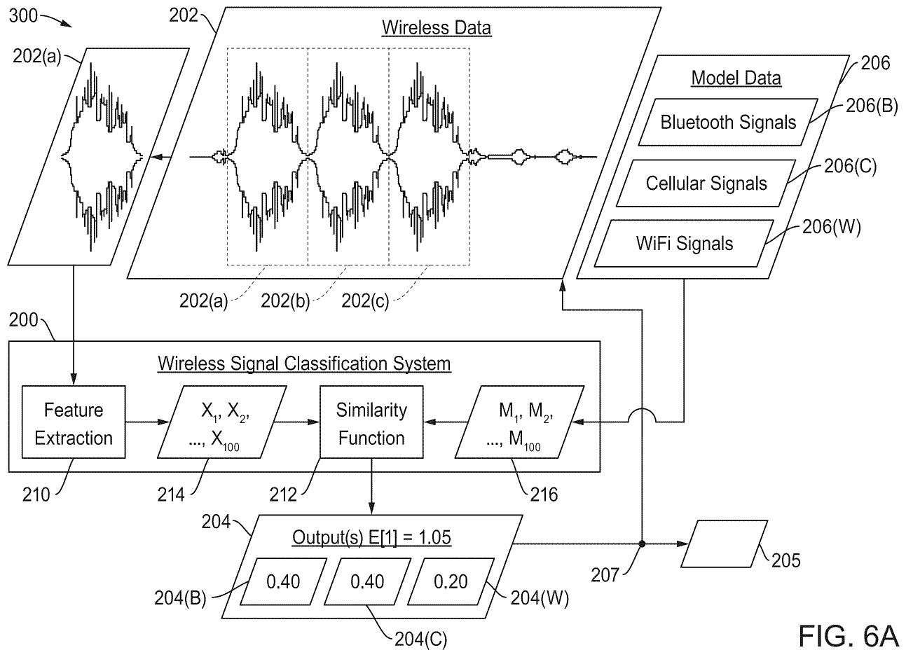

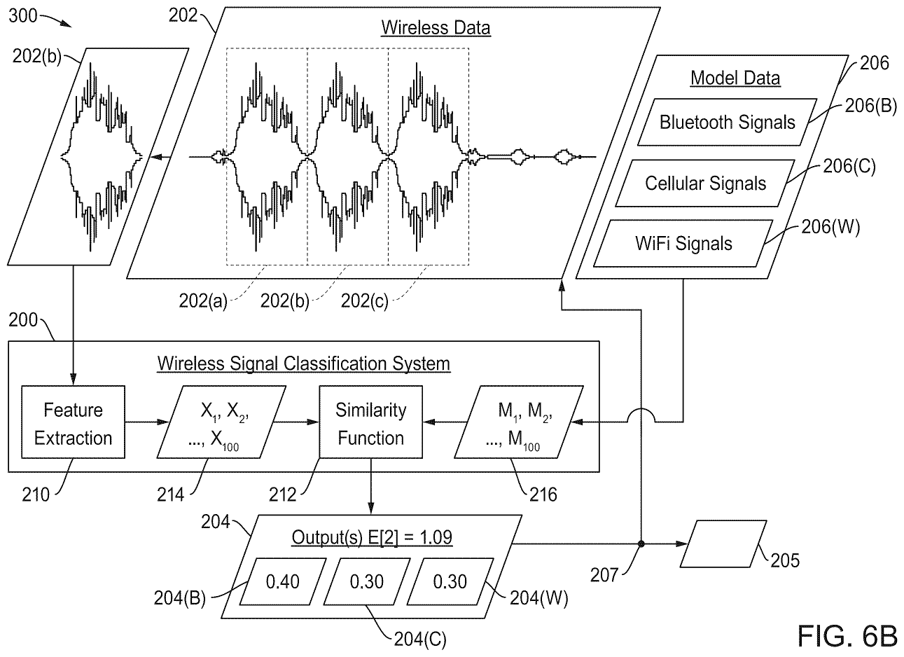

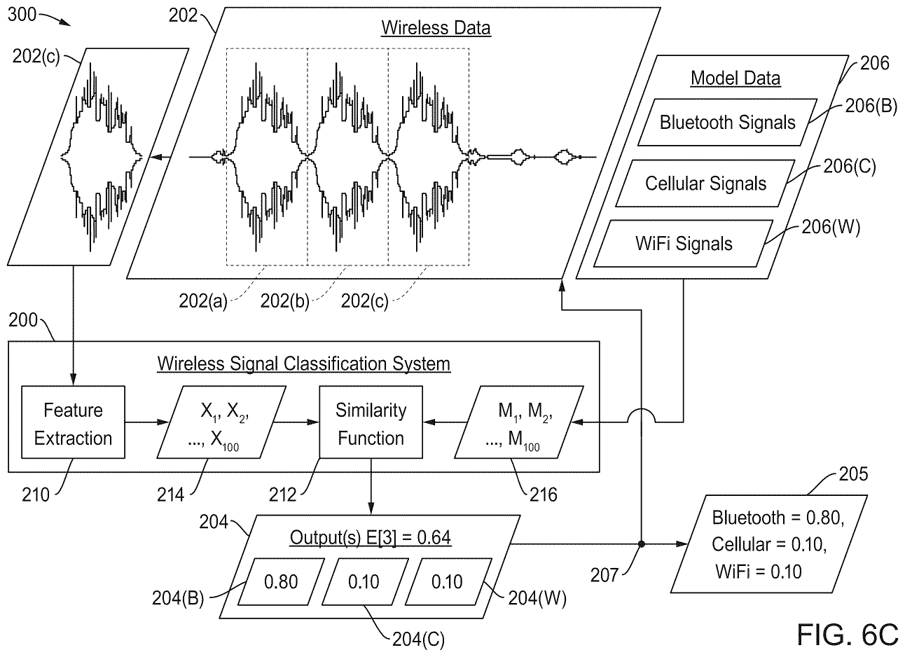

FIGS. 6A-C and 7A-B depict fast forward identification system 300, which processes succeeding chunks of input data based on the calculation of an entropy score, in accordance with some embodiments.

FIGS. 6A through 6C include schematic block diagrams which illustrate identification of a protocol in unknown wireless data, after processing all segments of input data. Referring to FIG. 6A, the processing for the first input data segment or chunk 202(a) is illustrated. The calculated probability scores 204 for the first chunk 202(a) are: Bluetooth=0.40, Cellular=0.40, WiFi=0.20. The entropy calculated for these probability scores is 1.05. It is noted that no final probability scores 205 are reported, since the processing has not completed or been terminated.

Next, as illustrated in FIG. 6B, the processing for the second input data segment or chunk 202(b) is illustrated. The calculated probability scores 204 for the second chunk 202(b) are: Bluetooth=0.40, Cellular=0.30, WiFi=0.30. The entropy calculated for these probability scores is 1.09. According to the present disclosure, because the entropy increased over the entropy for the previous chunk 202(a), processing will continue to the next chunk 202(c). It is noted that no final probability scores 205 are reported, since the processing has not completed or been terminated.

Next, as illustrated in FIG. 6C, the processing for the third input data segment or chunk 202(c) is illustrated. The calculated probability scores 204 for the second chunk 202(c) are: Bluetooth=0.80, Cellular=0.10, WiFi=0.10. The entropy calculated for these probability scores is 0.64. According to the present disclosure, because the entropy decreased over the entropy for the previous chunk 202(b), processing is stopped. Final probability scores 205 are reported as the probability scores 204 for the last chunk 202(c), i.e., Bluetooth=0.80, Cellular=0.10, WiFi=0.10, since the processing has completed.

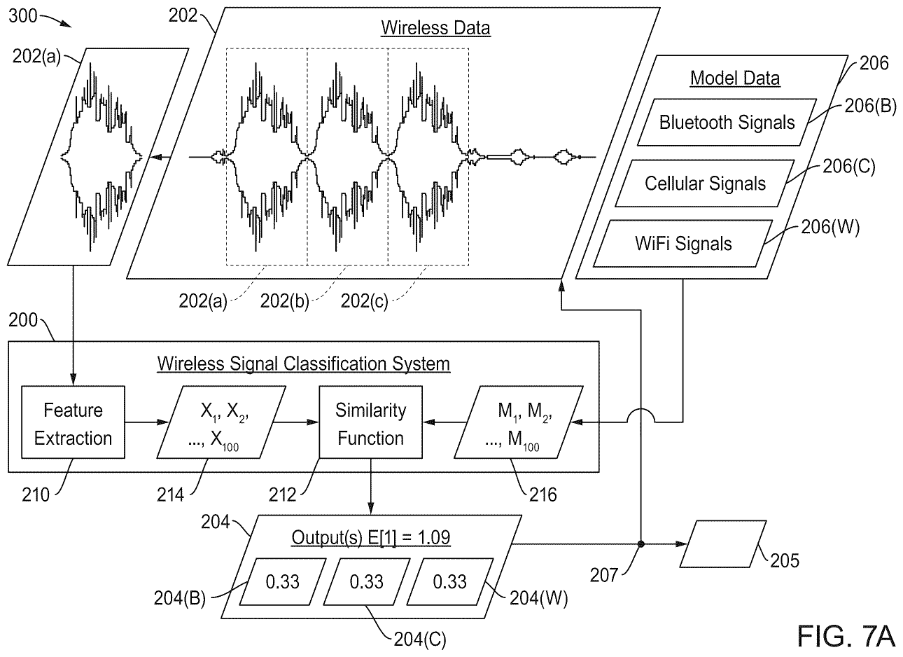

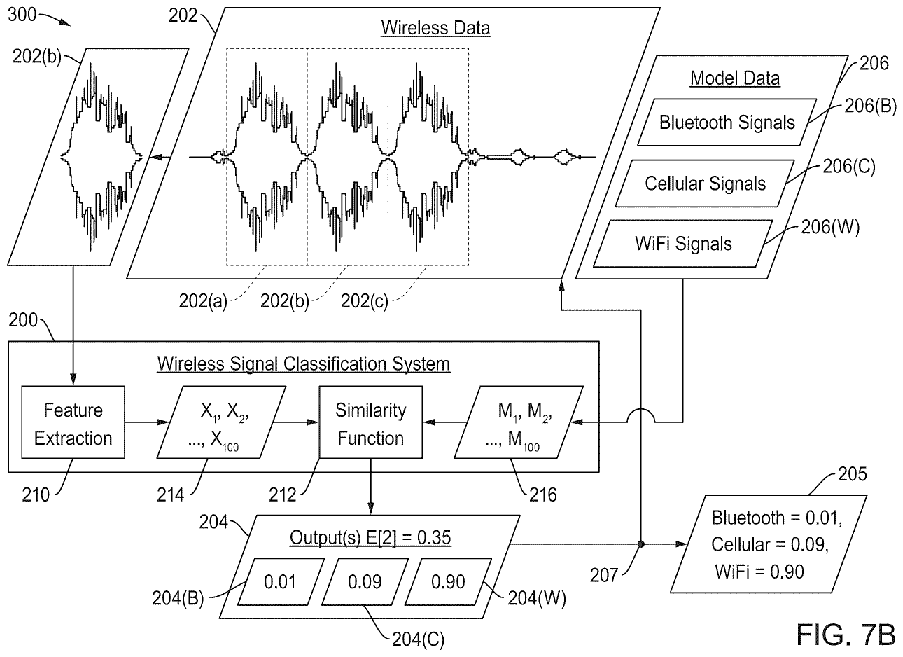

FIGS. 7A through 7B include schematic block diagrams which illustrate identification of a protocol in unknown wireless data, after processing fewer than all segments of input data. Referring to FIG. 7A, the processing for the first input data segment or chunk 202(a) is illustrated. The calculated probability scores 204 for the first chunk 202(a) are: Bluetooth=0.33, Cellular=0.33, WiFi=0.33. The entropy calculated for these probability scores is 1.09. It is noted that no final probability scores 205 are reported, since the processing has not completed or been terminated.

Next, as illustrated in FIG. 7B, the processing for the second input data segment or chunk 202(b) is illustrated. The calculated probability scores 204 for the second chunk 202(b) are: Bluetooth=0.01, Cellular=0.09, WiFi=0.90. The entropy calculated for these probability scores is 0.35. According to the present disclosure, because the entropy decreased over the entropy for the previous chunk 202(a), processing is stopped. Final probability scores 205 are reported as the probability scores 204 for the second chunk 202(b), i.e., Bluetooth=0.01, Cellular=0.09, WiFi=0.90, since the processing has been terminated. This early termination of processing results in a reduction in the processing load and time, resulting in a more efficient wireless signal identification process and system.

The output of wireless classification system 200 is the set of probability scores 205. In some exemplary systems, the highest score can be interpreted as being the identified wireless protocol. Thus, in the case of FIGS. 6A-6C, the results can be interpreted to identify the protocol in the unknown input data as Bluetooth, and, in the case of FIGS. 7A and 7B, the results can be interpreted to identify the protocol in the unknown input data as WiFi. Processing more data will result in more accurate probability estimates, but the use of entropy according to the present disclosure indicates the top score is unlikely to change. In general, the use of the top scoring label versus the set of probabilities is determined by external systems or the user of the output.

Hence, approaches of the invention save considerable processing cost and time because of an ability to eliminate the processing of large amounts of wireless data. In particular, reducing usage of feature extraction module 210 is beneficial, especially since, under operation, that is where the bulk of processing time and cost is expended. In other words, the wireless signal identification processing proceeds in chunks or segments. In some particular exemplary embodiments, the processing of a particular chunk builds on the information identified from the previous chunk or chunks. In these embodiments, a layer of the network keeps a running tally of statistics. To obtain the result, the state from previous chunks is maintained, so subsequent chunks incorporate the information from one or more previous chunks. The effect is the same, i.e., when the system receives data for a particular chunk, it only processes the wireless data of that chunk.

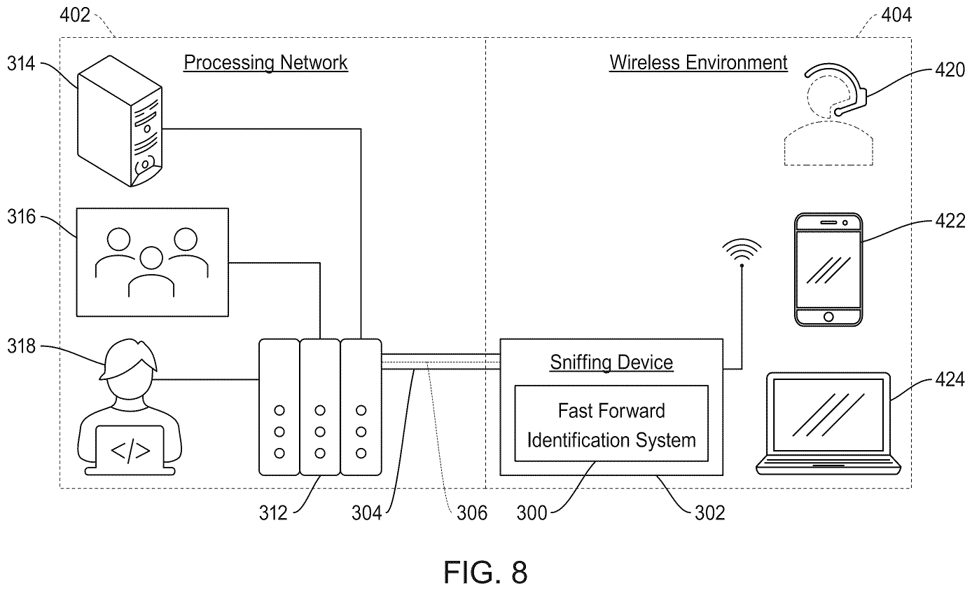

FIG. 8 shows radio frequency machine learning (RFML) fast forward system 400 in accordance with some embodiments. RFML fast forward system 400 includes fast forward identification system 300 of FIGS. 6 and 7 implemented on sniffing device 302. RFML fast forward system 400 may further include processing network 402 and wireless environment 404. The particular elements depicted in processing network 402 and wireless environment 404 are meant to be exemplary only and are not intended to be limiting. For example, in practice, processing network 402 and wireless environment 404 may include more or less elements than are depicted in FIG. 8.

Wireless environment 404 may include a number of wireless devices 420-424, the operation of which may be desirable to monitor or optimize. For example, wireless environment 404 may include Bluetooth device 420, Cellular device 422, and WiFi device 424. Sniffing device 302 may be placed in wireless environment 404 in order to receive radio transmissions from wireless devices 420-424 and classify them using fast forward identification system 300. Sniffing device 302 may further include an uplink 304 (solid line) to processing network 402. Processing network 402 may include a number of elements 312-318 that assist sniffing device 302 in the monitoring and/or optimization of wireless devices 420-424. For example, processing network 402 may include network switch 312, server 314, network engineers 316, and one or more network administrators 318.

In the course of operation, wireless devices 420-424 may generate a multitude of wireless transmissions that are received and stored by sniffing device 302. Using fast forward identification system 300, sniffing device 302 may classify each of wireless devices' 420-424 transmissions and transmit them as sniffed transmissions 306 (dashed line) on uplink 304 to network switch 312. Upon arriving at network switch 312 on processing network 402, the sniffed transmissions 306 may be subsequently sent to server 314 for storage.

By accessing server 314, network engineers 316 may analyze sniffed transmissions 306 in order to optimize the operation of wireless devices 420-424. For example, network engineers 316 may determine that the power and/or modulation characteristics of one or more of devices 420-424 should be changed in order to run more efficiently. Network engineers 316 may also determine that one or more of wireless devices 420-424 should be relocated in order to avoid interfering with adjacent wireless devices. Network engineers 316 may move sniffing device 302 throughout wireless environment 404 in order to optimize each of wireless devices 420-424.

Since sniffing device 302 is able to classify all types of wireless data, network engineers 316 may be able to identify unauthorized devices in wireless environment 404 by analyzing sniffed transmissions 306. Network administrator 318 may receive a list of wireless devices that are authorized for each wireless environment that they control, and network engineers 316 may comb through sniffed transmissions 306 in order to identify such unauthorized devices and mark them for removal. Alternatively, network engineers 316 may perform stateful packet inspection or deep packet inspection on any identified unauthorized devices in order to further classify them, block them, or record their higher-layer transmissions. Network administrators 316 may use sniffing device 302 to perform deep packet inspection on all wireless devices operating in wireless environment 404.

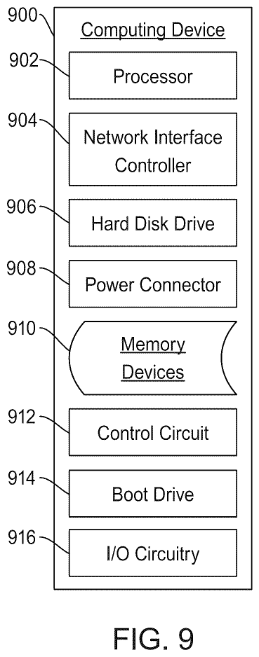

FIG. 9 shows computing device 900 in accordance with one or more embodiments. Computing device 900 may comprise essential elements of operation for one or more of devices 300-312 in the RFML fast forward system 400 of FIG. 8. However, this disclosure is not meant to be limiting. For example, devices 300-312 of RFML fast forward system 400 may include more or less elements than are depicted on computing device 900. The example computing device 900 includes processor 902, memory devices 910, power plug 908, network interface controller (NIC) 904, hard disk drive (HDD) 906, management and control circuit 912, boot drive 914, and input output (I/O) circuitry 916-918. Processor 902 comprises a processor and interface for communicating with various sensors and transducers via NIC 904 over I/O circuitry 916-918. Processor 902 also comprises a communication interface with memory 910.

In some embodiments processor 902 may be an SoC (System-on-a-Chip), a general purpose processor, an application specific integrated circuit (ASIC), or another device that provides processing capability and communicates with I/O circuitry 916-918. In some embodiments, management and control circuit 912 manages conditions of computing device 900 such as temperature conditions. In some embodiments, management and control circuit 912 includes an interface for connecting with an external heath monitoring system, such as an intelligent platform management interface (IPMI). In some embodiments, memory devices 910 are random access memory (RAM) devices such as double data rate fourth generation synchronous dynamic random-access memory (DDR4) or other suitable RAM devices.

Power connector 908 may be configured to receive electrical power via a cable connection, and in some embodiments, power connector 908 may be configured to couple with a backplane and receive electrical power via the backplane. In some embodiments, boot drive 914 is a solid state drive that stores program instructions for booting computing device 900. In some embodiments, boot instructions for computing device 900 may be stored in a remote location and boot drive 914 may be omitted.

Processor 902 communicates over I/O circuitry 916-918 with the aid of NIC 904. In some embodiments, I/O circuitry 916-918 may provide wired connections, such as small form factor pluggable IEEE 802.3 Ethernet ports or other suitable ports for a wired connection. I/O circuitry 916-918 may also support wireless connections, such as IEEE 802.11 WLAN connections, 3GPP 4G and 5G cellular connections, or a combination of both. I/O circuitry 916-918 may all provide wired connections, all provide wireless connections, or provide both wireless and wired connections.

HDD 906 may permanently store data and programs necessary for the functioning of computing device 200. HDD 906 may include traditional storage technology such as rotating magnetic platters that are accessed by one or more electromagnetic heads, or HDD 906 may include newer solid state disks (SSDs) that store information in flash memory, such as NAND flash and/or NOR flash. HDD 906 may employ any number of long-term storage transfer protocols, such as Parallel ATA (PATA), Serial ATA (SATA), and/or Small Computer System Interface (SCSI). HDD 906 may contain one or more programs that guide the operations of computing device 900 in communication with the various elements 300-316 and 420-424 in processing network 402 and wireless environment 404. The programs on HDD 906 may convert the components of computing device 900 from a general purpose computer to a special purpose computer for performing one or more of the radio frequency machine learning fast forward procedures described above.

In some embodiments, a radio frequency signal identification system is disclosed. The system receives signals from one or more wireless devices. The system includes a radio to receive a signal including unknown wireless data. The system is configured to divide the received signal into a plurality of ordered chunks. Each of the ordered chunks represents a respective portion of the received signal. The system also is configured to initiate feature extraction on the ordered chunks by feeding the ordered chunks sequentially into a neural network. The neural network creates a respective feature vector for each of the ordered chunks. As soon as the neural network has created a first feature vector for a first ordered chunk, the system also is configured to compare the first feature vector to a plurality of modeled signals using a similarity function. The similarity function generates a plurality of first feature vector probabilities that each gauge whether the received signal contains one of the modeled signals. A first probability of the first feature vector gauges whether the received signal contains a first modeled signal, a second probability of the first feature vector gauges whether the received signal contains a second modeled signal. A third probability of the first feature vector gauges whether the received signal contains a third modeled signal. The system also is configured to calculate a first system entropy value based on the probabilities of the first feature vector. As soon as the neural network has created a second feature vector for a second ordered chunk, the system also is configured to compare the second feature vector to the plurality of modeled signals using the similarity function. The similarity function generates a plurality of second feature vector probabilities that each gauge whether the received signal contains one of the modeled signals. A first probability of the second feature vector gauges whether the received signal contains the first modeled signal, a second probability of the second feature vector gauges whether the received signal contains the second modeled signal. A third probability of the second feature vector gauges whether the received signal contains the third modeled signal. The system also is configured to calculate a second entropy value based on the probabilities of the second feature vector. When the second system entropy value is not less than the first system entropy value, the system is configured to continue feature extraction on subsequent ordered chunks, and comprising subsequent feature vectors of the subsequent ordered chunks to the plurality of modeled signals using the similarity function to generate a plurality of subsequent feature vector probabilities that each gauge whether the received signal contains one of the modeled signals. Each subsequent feature vector has a respective subsequent entropy value. When the second or subsequent system entropy value is less than the first or a previous system entropy value, the system also is configured to cease feature extraction on the ordered chunks and accept the plurality of second or subsequent feature vector probabilities that each gauge whether the received signal contains one of the modeled signals. The system also is configured to output the accepted plurality of second or subsequent feature vector probabilities.

In some embodiments, a method for radio frequency signal identification is disclosed. The method includes receiving a signal including unknown wireless data. The method also includes dividing the received signal into a plurality of ordered chunks. Each of the ordered chunks represent a respective portion of the received signal. The method also includes initiating feature extraction on the ordered chunks by feeding the ordered chunks sequentially into a neural network. The neural network creates a respective feature vector for each of the ordered chunks. As soon as the neural network has created a first feature vector for a first ordered chunk, the method also includes comparing the first feature vector to a plurality of modeled signals using a similarity function. The similarity function generates a plurality of first feature vector probabilities that each gauge whether the received signal contains one of the modeled signals. A first probability of the first feature vector gauges whether the received signal contains a first modeled signal. As second probability of the first feature vector gauges whether the received signal contains a second modeled signal. A third probability of the first feature vector gauges whether the received signal contains a third modeled signal. The method also includes calculating a first system entropy value (SEV) based on the probabilities of the first feature vector. As soon as the neural network has created a second feature vector for a second ordered chunk, the method also includes comparing the second feature vector to the plurality of modeled signals using the similarity function. The similarity function generates a plurality of second feature vector probabilities that each gauge whether the received signal contains one of the modeled signals. A first probability of the second feature vector gauges whether the received signal contains the first modeled signal. A second probability of the second feature vector gauges whether the received signal contains the second modeled signal. A third probability of the second feature vector gauges whether the received signal contains the third modeled signal. The method also includes calculating a second system entropy value based on the probabilities of the second feature vector. When the second system entropy value is not less than the first system entropy value, the method also includes continuing feature extraction on subsequent ordered chunks, and comparing subsequent feature vectors of the subsequent ordered chunks to the plurality of modeled signals using the similarity function to generate a plurality of subsequent feature vector probabilities that each gauge whether the received signal contains one of the modeled signals. Each subsequent feature vector has a respective subsequent entropy value. When the second or a subsequent system entropy value is less than the first or a previous system entropy value, the method also includes ceasing feature extraction on the ordered chunks and accepting the plurality of second or subsequent feature vector probabilities that each gauge whether the received signal contains one of the modeled signals. The method also includes outputting the accepted plurality of second or subsequent feature vector probabilities.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A radio frequency signal identification system comprising:
a radio to receive a signal, wherein the signal includes a plurality of ordered chunks;
a feature extraction neural network to receive the plurality of ordered chunks, wherein the feature extraction neural network creates a respective feature vector for each of the plurality of ordered chunks of the signal;
a plurality of modeled signals, wherein each of the plurality of modeled signals include a wireless feature vector corresponding to a unique signal; and
a similarity function module configured to
compare a first feature vector for a first ordered chunk of the plurality of ordered chunks to the plurality of modeled signals using a similarity function,
generate a plurality of first feature vector probabilities that indicate whether the signal corresponds to one of the plurality of modeled signals,
determine a first system entropy value based on the first feature vector probabilities,
compare a second feature vector for a second ordered chunk of the plurality of ordered chunks to the plurality of modeled signals using the similarity function,
generate a plurality of second feature vector probabilities that indicate whether the signal corresponds to one of the plurality of modeled signals, and
determine a second system entropy value based on the plurality of second feature vector probabilities,
wherein the feature extraction neural network ceases processing of the plurality of ordered chunks based on the first system entropy value and the second system entropy value.

2. The radio frequency signal identification system of claim 1, wherein a first probability of the plurality of first feature vector probabilities indicates whether the signal corresponds to a first modeled signal of the plurality of modeled signals and a second probability of the first feature vector probabilities whether the signal corresponds to a second modeled signal of the plurality of modeled signals.

3. The radio frequency signal identification system of claim 2, wherein a first probability of the plurality of second feature vector probabilities indicates whether the signal corresponds to the first modeled signal of the plurality of modeled signals and a second probability of the second feature vector probabilities whether the signal corresponds to the second modeled signal of the plurality of modeled signals.

4. The radio frequency signal identification system of claim 3, wherein the first modeled signal includes a first wireless feature vector representing a first type of wireless signal and the second modeled signal includes a second wireless feature vector representing a second type of wireless signal.

5. The radio frequency signal identification system of claim 4, wherein the similarity function module is configured to determining whether the signal corresponds to the first type of wireless signal or the second type of wireless signal based on the plurality of second feature vector probabilities.

6. The radio frequency signal identification system of claim 5, wherein the system is configured to convert a remaining portion of the unknown wireless data in the signal to readable wireless data.

7. The radio frequency signal identification system of claim 1, further comprising a plurality of models for signals of interest to the system, wherein each of the plurality of models corresponds to a respective modeled signal of the plurality of modeled signals.

8. The radio frequency signal identification system of claim 1, wherein at least one of the plurality of modeled signals corresponds to at least one of a cellular signal and a wifi signal.

9. The radio frequency signal identification system of claim 1, further comprising a sniffing device to classify the received signal.

10. A method for identifying a radio frequency signal, the method comprising:
dividing the radio frequency signal into a plurality of ordered chunks;
feeding the plurality of ordered chunks into a feature extraction neural network;
creating a respective feature vector for each of the plurality of ordered chunks of the signal by the feature extraction neural network;
comparing a first feature vector for a first ordered chunk of the plurality of ordered chunks to a plurality of modeled signals using a similarity function;
generating a plurality of first feature vector probabilities that indicate whether the signal corresponds to one of the plurality of modeled signals;
determining a first system entropy value based on the first feature vector probabilities;
comparing a second feature vector for a second ordered chunk of the plurality of ordered chunks to the plurality of modeled signals using the similarity function;
generating a plurality of second feature vector probabilities that indicate whether the signal corresponds to one of the plurality of modeled signals;
determining a second system entropy value based on the plurality of second feature vector probabilities; and
ceasing processing of the plurality of ordered chunks by the feature extraction neural network based on the first system entropy value and the second system entropy value.

11. The method of claim 10, further comprising identifying the signal as one of the plurality of modeled signals based on the first system entropy value or the second system entropy value.

12. The method of claim 10, wherein each of the plurality of modeled signals include a wireless feature vector extracted from a unique wireless signal.

13. The method of claim 10, wherein a first probability of the plurality of first feature vector probabilities indicates whether the signal corresponds to a first modeled signal of the plurality of modeled signals and a second probability of the first feature vector probabilities whether the signal corresponds to a second modeled signal of the plurality of modeled signals.

14. The method of claim 13, wherein a first probability of the plurality of second feature vector probabilities indicates whether the signal corresponds to the first modeled signal of the plurality of modeled signals and a second probability of the second feature vector probabilities whether the signal corresponds to the second modeled signal of the plurality of modeled signals.

15. The method of claim 14, wherein the first modeled signal includes a first wireless feature vector representing a first type of wireless signal and the second modeled signal includes a second wireless feature vector representing a second type of wireless signal.

16. The method of claim 15, further comprising determining whether the signal corresponds to the first type of wireless signal or the second type of wireless signal based on the plurality of second feature vector probabilities.

17. The method of claim 16, further comprising converting a remaining portion of unknown wireless data in the signal to readable wireless data.

18. The method of claim 17, further comprising receiving the signal, wherein the signal includes the unknown wireless data.

19. The method of claim 10, wherein each of the plurality of ordered chunks corresponds to a respective portion of the signal.

20. A non-transitory computer-readable medium having stored thereon processor-executable instructions for performing operations for identifying a radio frequency signal, the operations comprising:
dividing the radio frequency signal into a plurality of ordered chunks;
feeding the plurality of ordered chunks into a feature extraction neural network;
creating a respective feature vector for each of the plurality of ordered chunks of the signal by the feature extraction neural network;
comparing a first feature vector for a first ordered chunk of the plurality of ordered chunks to a plurality of modeled signals using a similarity function;
generating a plurality of first feature vector probabilities that indicate whether the signal corresponds to one of the plurality of modeled signals;
determining a first system entropy value based on the first feature vector probabilities;
comprising a second feature vector for a second ordered chunk of the plurality of ordered chunks to the plurality of modeled signals using the similarity function;
generating a plurality of second feature vector probabilities that indicate whether the signal corresponds to one of the plurality of modeled signals;
determining a second system entropy value based on the plurality of second feature vector probabilities; and
ceasing processing of the plurality of ordered chunks by the feature extraction neural network based on the first system entropy value and the second system entropy value.
